(19) United States
(12) Patent Application Publication
(10) Pub. No.: US 2020/0083651 A1
(43) Pub. Date: Mar. 12, 2020

(54) SECURITY CONNECTOR

(71) Applicant: InVue Security Products Inc., Charlotte, NC (US)

(72) Inventors: William B. Howell, Charlotte, NC (US); Darin J. Shaw, Waxhaw, NC (US); Jonathon D. Phillips, Fort Mill, SC (US); Eric Brutke, Tega Cay, SC (US)

(21) Appl. No.: 16/494,169

(22) PCT Filed: Mar. 15, 2018
(86) PCT No.: PCT/US18/22614

§ 371 Date: Sep. 13, 2019

Related U.S. Application Data
(60) Provisional application No. 62/472,635, filed on Mar. 17, 2017.
(60) Provisional application No. 62/500,155, filed on May 2, 2017.

(51) Int. Cl. H01R 13/703; H01R 13/639; H01R 13/6581; H01R 24/60; G08B 13/14

(52) U.S. Cl. CPC H01R 13/7033; H01R 13/6397; H01R 2107/00; H01R 24/60; G08B 13/1409; H01R 13/6581

(57) ABSTRACT

In one example, a connector for providing security to an article of merchandise is provided, wherein the article of merchandise includes an input port and internal circuitry. The connector includes a connection portion configured to releasably engage the input port of the article of merchandise. The connector also includes a conductive shield and at least one pair of ground conductors. At least one of the ground conductors is configured to electrically connect to the conductive shield to define a sense loop when the connector is engaged with the article of merchandise. Interruption of the sense loop is indicative of a security event.

### CROSS REFERENCE TO RELATED APPLICATIONS

This application claims the benefit of priority to U.S. Provisional Application No. 62/472,635 filed on Mar. 17, 2017, and U.S. Provisional Application No. 62/500,155 filed on May 2, 2017, the entire disclosures of which are incorporated herein by reference.

### FIELD OF THE INVENTION

Embodiments of the present invention relate generally to connectors for electronic devices, including connectors for securing electronic devices from theft.

### BACKGROUND OF THE INVENTION

Retailers routinely display articles of merchandise, such as portable computers (e.g. notebooks, laptops, tablets, etc.), mobile phones, e-readers, media players, and the like for customers to evaluate before making a purchase. These articles of merchandise are continually being made smaller and lighter in weight due to advances in technology and materials. As a result, such merchandise is increasingly vulnerable and susceptible to theft. At the same time, the retail price and profit margin for such merchandise continues to decline. Accordingly, these articles of merchandise need to be secured by a security device that effectively and cost efficiently protects the merchandise from theft.

It is common in the retail security industry to have electronic devices tethered to a store fixture to prevent theft yet allow a customer to interact with the device. In addition, it is desirable to provide power to the electronic device so that the device may be charged and operable for use by a potential customer. Therefore, there is a need for improved connectors that are capable of providing both power and security to the electronic device without affecting the existing functionality of the connector.

### BRIEF SUMMARY

Embodiments of the present invention are directed towards connectors, security systems, and methods for providing security to an article of merchandise. In one embodiment, a connector includes a connection portion configured to releasably engage an input port of an article of merchandise, wherein the connection portion has a conductive shield. The connector also includes a plurality of conductors, at least one pair of the conductors being ground conductors. At least one of the pair of ground conductors is configured to electrically connect to the conductive shield to define a sense loop when the connector is engaged with the input port of the article of merchandise, and interruption of the sense loop is indicative of a security event.

In another embodiment, a security system is provided and includes a controller and a cord configured to operably engage the controller. The security system also includes a connector operably engaged with the cord and configured to releasably engage the input port of the article of merchandise, wherein the connector comprises a conductive shield and a plurality of conductors, and at least one pair of the conductors are ground conductors. At least one of the at least one pair of ground conductors is configured to electrically connect to the conductive shield to define a sense loop when the connector is engaged with the article of merchandise. In addition, the at least one of the pair of ground conductors is configured to transmit a signal when the connector is engaged with the article of merchandise, and the controller is configured to detect a change in the signal that is indicative of a security event.

In another embodiment, a method is provided and includes transmitting power and security signals through a connector engaged with an article of merchandise, the connector comprising a conductive shield and a plurality of conductors, at least one pair of the conductors being ground conductors, at least one of the pair of ground conductors configured to electrically connect to the conductive shield to define a sense loop when the connector is engaged with the article of merchandise. The method further includes detecting an interruption in the sense loop that is indicative of a security event.

In one embodiment, a connector includes a connection portion configured to releasably engage the input port of the article of merchandise, the connection portion comprising a conductive shield. The connector also includes a plurality of conductors, at least one of the conductors being a ground conductor. The ground conductor is configured to electrically connect to the conductive shield to define a sense loop when the connector is engaged with the input port of the article of merchandise, and interruption of the sense loop is indicative of a security event.

In another embodiment, a connector includes a connection portion configured to be operably engaged with a cord and configured to releasably engage the input port of the article of merchandise, the connection portion comprising a conductive shield. The connector also includes a plurality of conductors, wherein at least a pair of the conductors (e.g., data conductors) is configured to electrically connect to one another prior to engagement with the input port of the article of merchandise to form a sense loop and to interrupt the sense loop when the connector is engaged with the input port of the article of merchandise. In addition, formation of the sense loop is indicative of a security event.

In one embodiment, a connector includes a connection portion configured to releasably engage the input port of the article of merchandise, the connection portion comprising at least one EMC spring contact. The connector also includes a plurality of conductors, at least one of the conductors being a ground conductor. The ground conductor is configured to electrically connect to the EMC spring contact to define a sense loop when the connector is engaged with the input port of the article of merchandise, and interruption of the sense loop is indicative of a security event.

### BRIEF DESCRIPTION OF THE DRAWINGS

FIG. 1 is a schematic of a security system according to one embodiment of the present invention.

FIG. 2 is a perspective view of a connector according to one embodiment of the present invention.

FIG. 3 is a plan view of a conductive shield according to one embodiment of the present invention.

FIG. 4 is a perspective view of a connector engaged with an input port according to another embodiment of the present invention.

FIG. 5 is a cross-sectional view of a conventional connector engaged with an input port.

FIG. 6 is a cross-sectional view of a connector engaged with an input port according to another embodiment of the present invention.

FIG. 7 is an exploded perspective view of a connector and an input port according to another embodiment of the present invention.

FIG. 8 is a plan view of the connector shown in FIG. 7.

FIG. 9 is a plan view of the connector shown in FIG. 7 engaged with the input port.

FIG. 10A is a cross-sectional view of a connector according to another embodiment of the present invention.

FIG. 10B is a cross-sectional view of the connector shown in FIG. 10A engaged with an input port according to another embodiment of the present invention.

FIG. 11 is a cross-sectional view of a connector engaged with an input port according to another embodiment of the present invention.

### DETAILED DESCRIPTION OF EMBODIMENTS OF THE INVENTION

Embodiments of the present invention will now be described more fully hereinafter with reference to the accompanying drawings, in which exemplary embodiments of the invention are shown. This invention may, however, be embodied in many different forms and should not be construed as limited to the embodiments set forth herein. Rather, the exemplary embodiments are provided so that this disclosure will be thorough and complete, and will fully convey the scope of the invention to those skilled in the art.

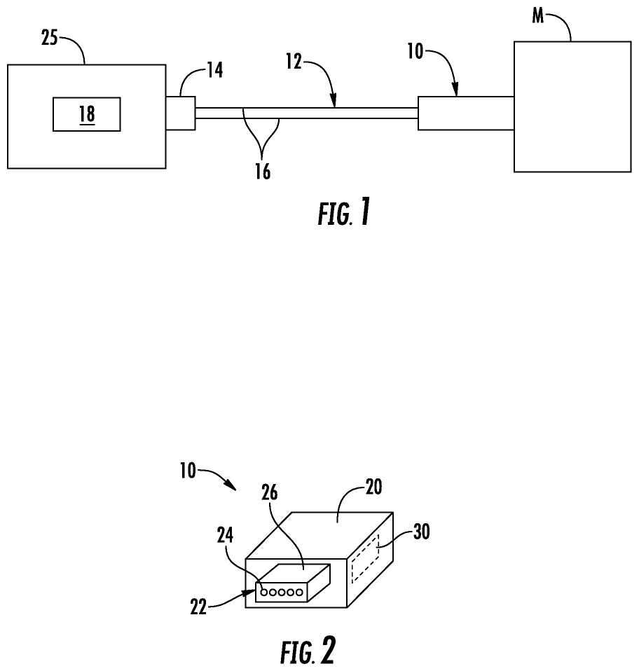

One or more embodiments of a connector 10 for securing an article of merchandise “M” from theft are described below. The article of merchandise M may be a display model or an operational sample of electronic merchandise, such as portable computers (e.g. notebooks, laptops, tablets, etc.), e-readers, mobile phones, smart phones, media players, and the like, for a customer to examine before making a decision to purchase the item. The article of merchandise M may be typically displayed in a manner that permits a prospective purchaser to evaluate the operation and features of the merchandise, while protecting the merchandise from a potential thief. A power cord or tether 12 may be operably engaged with the article of merchandise M at one end, and according to one embodiment, a security event (e.g., removal, cutting, or tampering of the power cord) may result in the generation of a security signal (e.g., an audible and/or a visual alarm). For example, the power cord 12 may be operably engaged with an alarm device 25 configured to generate a security signal upon detecting a security event. In one embodiment, the power cord 12 includes a connector 14 configured to operably engage an alarm device 25 (see, e.g., FIG. 1).

Embodiments of the present invention provide for the delivery of at least power to the article of merchandise M on display through a power cord 12, cable, or the like. The power cord 12 may include a plurality of conductors 16. For example, a pair of conductors 16 in the power cord 12 (e.g., a positive power line and a ground line) may provide power to the article of merchandise M. An input power source or controller 18 may be in electrical communication with the power cord for transmitting power and other signals through the cord 12 and to the article of merchandise M. The power cord 12 may include additional conductors 16 if desired, such as for transmitting data, audio, video, optical and/or communication signals. Moreover, in one embodiment, the power cord 12 includes at least one conductor 16 for transmitting a security signal. For example, the power cord 12 may include a plurality of conductors 16, one of which for transmitting a signal to the connector 10, and a second conductor for returning the signal back through the power cord. Should the signal be disrupted (e.g., the cord 12 is removed or cut), a security signal may be generated. For instance, an audible and/or a visible signal may be generated. In addition, the functionality of the article of merchandise M may be interrupted and locked from further use without being overridden by an authorized user, such as by inputting a passcode or using an appropriate key.

One end of the power cord 12 includes a connector 10 configured to electrically couple to the article of merchandise M. The opposite end of the power cord is configured to be coupled to a power source 18, such as a USB-port on another electronic device or an electrical outlet. Thus, the power cord 12 may include a USB connector or the like that is electrically connected to the connector 10 at the opposite end of the cord. In other embodiments, the power cord 12 may be electrically coupled to an alarm device 25 and/or sensor, as explained in further detail below. In one embodiment, the connector 10 is configured to provide at least power and security signals to the article of merchandise.

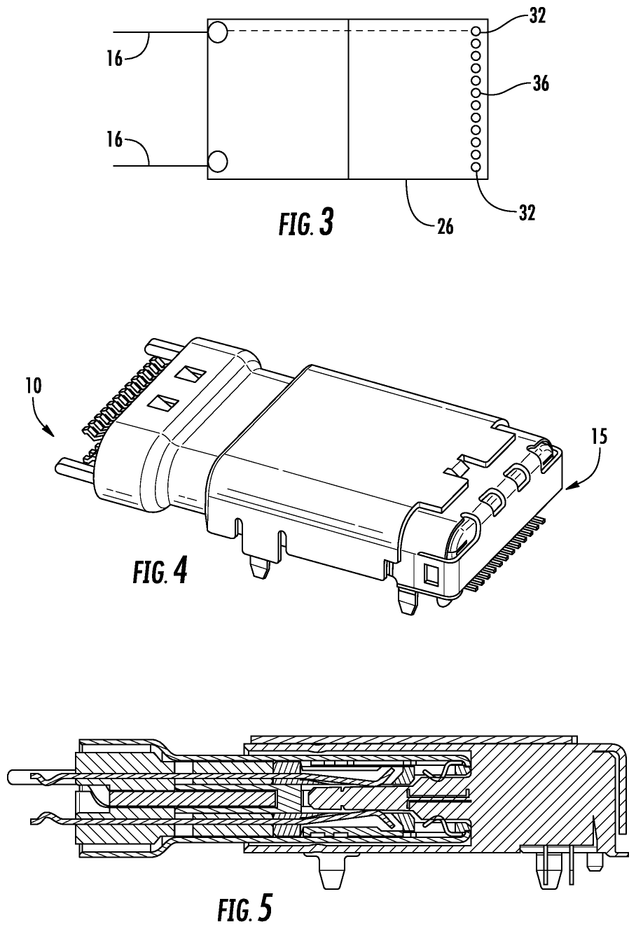

Generally, the connector 10 may include a body portion 20 and a connection portion 22 extending outwardly therefrom (see, e.g., FIG. 2). The body portion 20 and connection portion 22 may be separate members coupled to one another or integrally formed as a single component. Although the body portion 20 and the connection 22 portion may be various sizes and configurations, the connection portion is illustrated in this example as having a smaller cross-sectional dimension than the body portion. The power cord 12 is coupled to the body portion 20, while the connection portion 22 is configured to be inserted within an input port of the article of merchandise M so as to be electrically connected thereto. The body portion 20 may be hard wired to the power cord 12 or connected using a suitable releasable coupling.

The connection portion 22 comprises a plurality of conductors 24, contacts, or pins that correspond to the conductors 16 in the power cord, as discussed above. The connection portion 22 may include any number of conductors 24, such as 2, 4, 6, 8, 10, 12, 24, etc. The conductors 24 may be positioned within a conductive shield 26. Thus, the shield 26 may surround the conductors 24 and form an outer surface of the connection portion 22. The shield 26 may include one or more engagement features that facilitate engagement with corresponding engagement features in the input port 15 of the article of merchandise M. In one embodiment, the conductive shield 26 is a conductive metal material. In the instance where the connector 10 is a USB type-C connector, the connection portion 22 may also include one or more electromagnetic compatibility (EMC) spring contacts 34 that is in electrical contact or electrically connected to the conductive shield 26. In the instance where the connector 10 is a USB type-C connector, the connection portion 22 may also include one or more retention or side latches 38 configured for retaining the connection portion within the input port 15 when inserted therein and/or providing an additional ground return path.

The input port 15 of the article of merchandise M may include a plurality of conductors, pins, or contacts that are configured to electrically connect to corresponding conductors 24 on the connection portion 22 and/or conductive shield 26 when the connection portion is engaged with the input port (see, e.g., FIG. 4). In one embodiment, the input port 15 includes a plurality of conductors that are configured to electrically connect to the conductors 24 and/or the conductive shield 26 of the connector. The article of merchandise M may also include internal circuitry 17, such as a printed circuit board or the like, that is electrically connected to the input port.

The cable 14, shield 26, and/or body portion 20 may house a processor 30 for communicating with the article of merchandise M. The processor 30 may be configured to perform a variety of functions, such as authenticating that the connector is compatible with the article of merchandise. The processor 30 could also be configured to detect the orientation of the connector 10. In this regard, the connector 10 may be bi-directional in that the connector may be inserted into an input port of the article of merchandise M in a first orientation and a second opposite orientation, which is unlike conventional USB-A and micro-USB connectors. For example, the connector 10 may be inserted in orientations 180 degrees opposite from one another. The processor 30 may, in turn, detect the orientation of the connector so that the electrical signals may be routed to the proper conductors in the connection portion. Moreover, the processor 30 may be configured to determine the power or voltage requirements of the article of merchandise M so that the appropriate voltage may be delivered to the article.

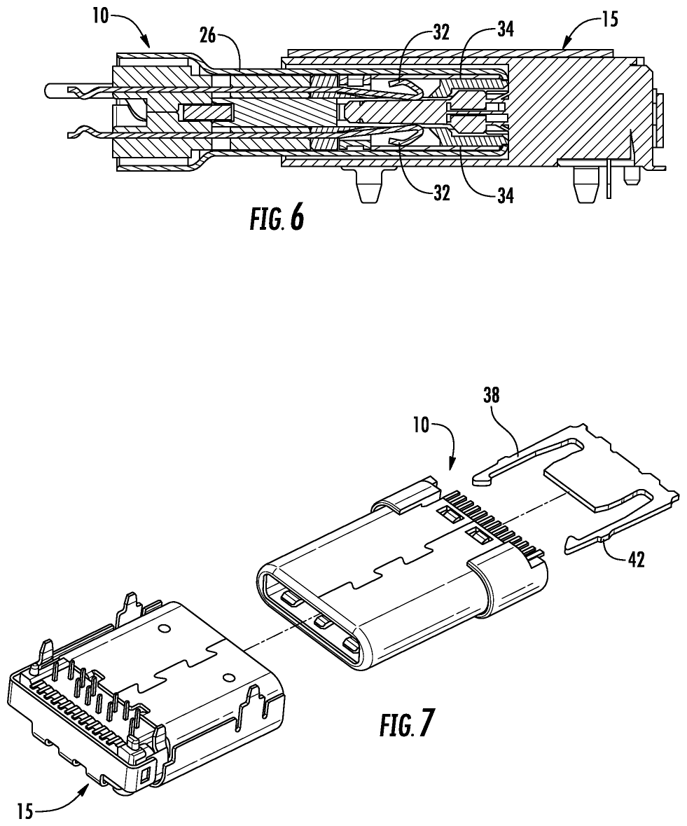

The connector 10 is further configured to facilitate detection of a security event, such as removal or cutting of the power cord 12. In this regard, FIG. 3 shows an embodiment of a connector 10 that includes at least one pair of ground conductors 32 that are not electrically connected to the conductive shield 26 when the connector is not connected to the article of merchandise M. When the connector 10 is inserted within the input port 15 of the article of merchandise M, one or more of the ground conductors 32 become electrically connected to the conductive shield 26 due to interaction between the ground conductor(s) and the EMC spring contact(s) 34, thereby completing an electrical circuit. In other words, the conductive shield 26 is electrically connected to one or more of the ground conductors 32 via the EMC spring contacts 34. FIG. 5 shows a conventional USB type-C connector engaged with an input port, while FIG. 6 shows a connector 10 according to an embodiment of the present invention. As shown, the ends of the ground conductors 32 have been modified such that when the connector 10 is inserted within the input port 15, the ends of the ground conductors are deflected into engagement with the EMC spring contacts. Thus, the ends of the ground conductors 32 are configured to deflect into electrical contact with the conductive shield 26. In this example embodiment, the ends of one or more of the ground conductors 32 may have a generally “U” or “C” shape.

FIG. 11 shows another embodiment whereby the ends of the ground conductors 32 may not necessarily need to be modified for defining a sense loop. However, in this example, the spring contacts 34 may be modified in a way that ensures electrical contact is made between the ground conductors 32 and the spring contacts 34. For instance, any gaps between the spring contacts 34 that are present in conventional connectors may be eliminated or reduced in size to facilitate an electrical connection between the ground conductors 32 and the spring contacts 34 when the connector 10 is engaged with the input port 15.

As noted above, the power cord 12 may include a plurality of conductors 16, one of which is for transmitting a signal to the connector 10, and at least a second conductor for returning the signal back through the power cord. As long as the connector 10 is electrically connected to the article of merchandise M, the sense loop through the ground conductor(s) 32 and the conductive shield 26 is uninterrupted. Should the sense loop be disrupted (e.g., the cord 12 is removed or cut), a security signal may be generated. Thus, as soon as the connector 10 is removed from the article of merchandise M, the shorted conductors would open or otherwise lose electrical connectivity, resulting in the generation of a security signal. FIG. 3 also shows that the connector 10 includes a conductor 36 that allows power to be provided to the connector, which may be used to provide power to the article of merchandise M. Thus, the article of merchandise M may be charged via the connector 10.

In one embodiment shown in FIG. 3, one conductor 16 may be configured to transmit or receive a security signal generated by the controller 18 through one or more of the ground conductors 26, which may be tied together, such as via processor 30. A second conductor may be connected to the conductive shield 26 and configured to transmit or receive a security signal generated by the controller 18. Prior to insertion within the input port 15, the ground conductors 32 are not electrically connected to the conductive shield 26. However, when inserted within the input port 15, each ground conductor 32 is shorted to the conductive shield 26. Thus, a sense loop is configured to be defined via the ground conductors 32 and conductive shield 26 between the alarm device 25 and the article of merchandise M.

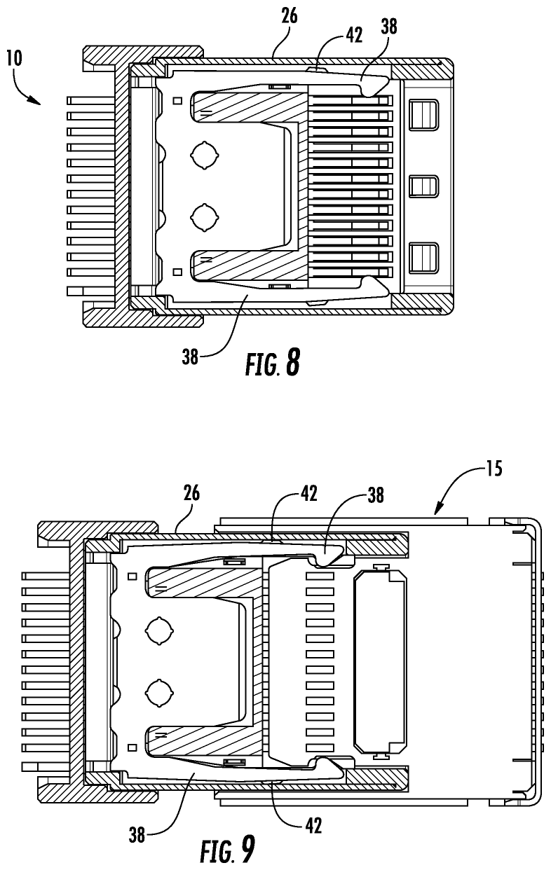

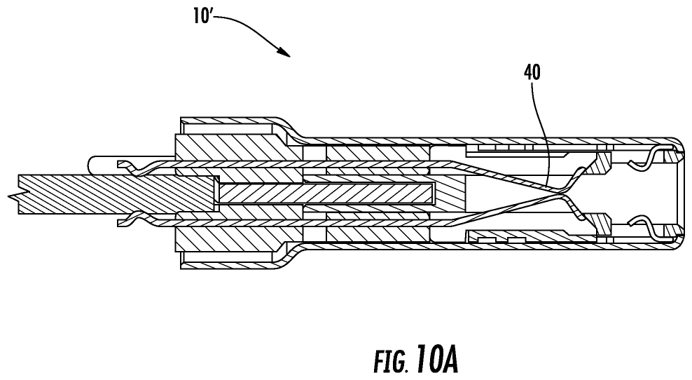

In another embodiment shown in FIGS. 7-9, a connector 10 includes a retention latch 38 that is configured to define a sense loop with the conductive shield 26. The retention latch 38 includes a pair of arms that are each configured to engage the conductive shield 26 when the connection portion 22 is inserted within the input port 15 (see, e.g., FIG. 9). Prior to being inserted within the input port 15, the retention latch 38 is electrically isolated from the conductive shield 26 (see, e.g., FIG. 8), which is unlike conventional USB-C connectors. In this regard, each of the arms of the retention latch 38 may include a protuberance or engagement member 42 configured to engage the conductive shield 26. The protuberance(s) 42 may be defined on an outer edge of the arms of the retention latch 38. Thus, when the connection portion 22 is inserted within the input port 15, both arms of the retention latch 38 are configured to engage and electrically connect to the conductive shield 26. Therefore, as before, an electrical connection with the conductive shield 26 may define a sense loop with the connector 10.

In one particular example, the connector is a USB type-C connector. Thus, the connector may include two or more pairs of ground conductors. The USB type-C connector may have the configuration described in Universal Serial Bus Type-C Cable and Connector Specification, Revision 1.1, Apr. 3, 2015, Revision 1.2, Mar. 25, 2016, and Revision 1.3, Jul. 14, 2017. The USB-type C connector may cooperate with USB type-C cables for power and data transfer, including those that function using the Universal Serial Bus Power Delivery Specification, Revision 2.0, Aug. 11, 2014 and Revision 3.0, Jan. 12, 2017. In addition, the USB type-C connector may operate using various USB standards, including USB 2.0, 3.0, 3.1, and 3.2.

In some embodiments, the power cord 12 is coupled to an alarm device 25 and/or sensor. For instance, the power cord 12 may electrically connect an alarm device 25 and/or sensor to the article of merchandise M. Thus, upon the occurrence of a security event, the alarm device 25 may include circuitry for detecting the security event and generating an appropriate security signal. For example, the alarm device 25 may be similar to those manufactured by InVue Security Products Inc. For example, the alarm device 25 may include a display module, base, stand, or mounting member configured to removably support the article of merchandise M, as well as provide power and security to the article of merchandise. According to some embodiments, the alarm device may be similar to those disclosed in U.S. Pat. No. 7,710,266, entitled Security System with Product Power Capability and issued May 4, 2010, U.S. Pat. No. 7,727,843, entitled Programmable Alarm Module and System for Protecting Merchandise and issued Jun. 15, 2010, and U.S. Pat. No. 9,747,765, entitled Recoiler for a Merchandise Security System and issued Aug. 29, 2017, each of which is incorporated by reference herein in its entirety. Moreover, the alarm device 25 could be integrated with an input power source or controller 18, such as for providing and/or receiving power and/or security signals from the connector 10 and/or the article of merchandise M.

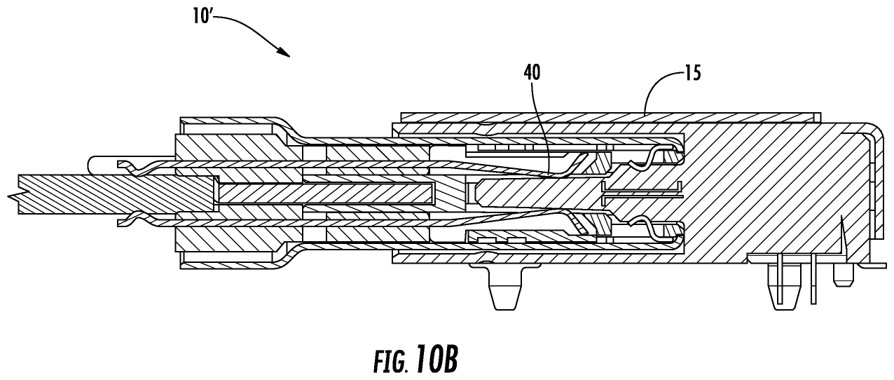

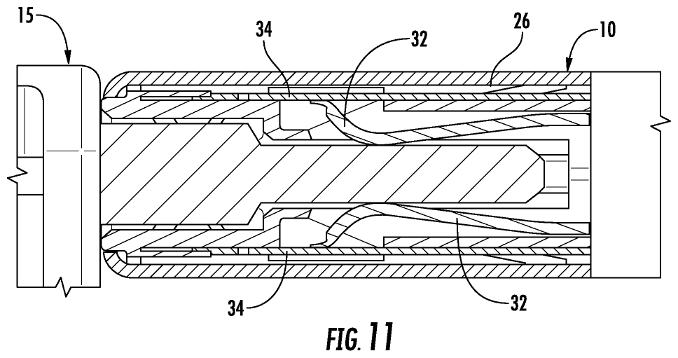

In another embodiment shown in FIGS. 10A-B, a connector 10′ is provided. In this embodiment, at least a pair of conductors 40 (e.g., a pair of data conductors of a USB-C connector) disposed within the conductive shield 26 form a closed loop prior to insertion within the input port 15 (see, e.g., FIG. 10A). Thus, the conductors 40 may be modified in shape such that they are in direct electrical contact prior to insertion within the input port 15. In this way, a closed circuit or sense loop is formed prior to inserting the connector 10′ within the input port 15. When the connector 10′ is inserted within the input port 15, the conductors 40 are biased away from one another due to engagement with the input port (see, e.g., FIG. 10B). Due to engagement with the input port, the sense loop defined by the conductors 40 is open. Removal of the connector 10′ from the input port 15 results in closing the circuit or again forming the sense loop, which would be indicative of a security event. If the alarm device 25 is armed, the alarm device may be configured to generate a security signal in response to detecting formation of the sense loop.

Embodiments of the present invention provide advantages over similar connectors that may otherwise be incapable of providing security to the article of merchandise. This functionality is advantageous in a retail environment where articles of merchandise are on display for inspection by a customer.

The foregoing has described one or more embodiments of a connector for securing an article of merchandise from theft. Those of ordinary skill in the art will understand and appreciate that numerous variations and modifications of the invention may be made without departing from the spirit and scope of the invention. Accordingly, all such variations and modifications are intended to be encompassed by the appended claims.

1. A connector for providing security to an article of merchandise, the article of merchandise comprising an input port, the connector comprising:
a connection portion configured to releasably engage the input port of the article of merchandise, the connection portion comprising a conductive shield; and
a plurality of conductors, at least one pair of the conductors being ground conductors,
wherein at least one of the pair of ground conductors is configured to electrically connect to the conductive shield to define a sense loop when the connector is engaged with the input port of the article of merchandise, and
wherein interruption of the sense loop is indicative of a security event.

2. The connector according to claim 1, wherein at least a pair of the plurality of conductors are configured to transmit power between the connector and the article of merchandise.

3. The connector according to claim 1, wherein the connection portion comprises the plurality of conductors.

4. The connector according to claim 1, wherein the at least one pair of ground conductors are not shorted to the conductive shield prior to insertion within the input port.

5. The connector according to claim 1, wherein the conductive shield surrounds the pair of ground conductors.

6. The connector according to claim 1, wherein the connection portion comprises at least one EMC spring contact electrically connected to the conductive shield, and wherein the at least one of the pair of ground conductors is configured to deflect into engagement with a corresponding EMC spring contact when the connection portion is inserted within the input port.

7. The connector according to claim 1, wherein the connection portion is configured to electrically connect to the article of merchandise in different orientations.

8. The connector according to claim 1, wherein the plurality of conductors comprise two pairs of ground conductors.

9. The connector according to claim 1, wherein the plurality of conductors are configured to transmit data between the connector and the article of merchandise.

10. The connector according to claim 1, wherein the plurality of conductors are housed within the connection portion.

11. (canceled)

12. A security system for providing security to an article of merchandise, the article of merchandise comprising an input port and internal circuitry, the security system comprising:
a controller;
a cord configured to operably engage the controller; and
a connector operably engaged with the cord and configured to releasably engage the input port of the article of merchandise, the connector comprising a conductive shield and a plurality of conductors, at least one pair of the conductors being ground conductors,
wherein at least one of the at least one pair of ground conductors is configured to electrically connect to the conductive shield to define a sense loop when the connector is engaged with the article of merchandise,
wherein the at least one of the pair of ground conductors is configured to transmit a signal when the connector is engaged with the article of merchandise, and
wherein the controller is configured to detect a change in the signal that is indicative of a security event.

13. The security system according to claim 12, wherein the connector is a USB type-C connector.

14. The security system according to claim 12, wherein the at least one pair of ground conductors are not shorted to the conductive shield prior to insertion within the input port.

15. The security system according to claim 12, wherein the conductive shield surrounds the pair of ground conductors.

16. (canceled)

17. The security system according to claim 12, wherein the plurality of conductors comprise two pairs of ground conductors.

18. The security system according to claim 12, wherein the plurality of conductors are configured to transmit data between the connector and the article of merchandise.

19. The security system according to claim 12, wherein the connector comprises at least one EMC spring contact electrically connected to the conductive shield, and wherein the at least one of the pair of ground conductors is configured to deflect into engagement with a corresponding EMC spring contact when the connection portion is inserted within the input port.

20. A method for securing an article of merchandise comprising:
transmitting power and security signals through a connector engaged with an article of merchandise, the connector comprising a conductive shield and a plurality of conductors, at least one pair of the conductors being ground conductors, at least one of the pair of ground conductors configured to electrically connect to the conductive shield to define a sense loop when the connector is engaged with the article of merchandise; and
detecting an interruption in the sense loop that is indicative of a security event.

21. (canceled)

22. (canceled)

23. (canceled)

24. The connector according to claim 1, wherein the connection portion comprises at least one EMC spring contact, and wherein the at least one pair of ground conductors is configured to electrically connect to the EMC spring contact to define a sense loop when the connector is engaged with the input port of the article of merchandise.

25. The connector according to claim 24, wherein the connection portion comprises a plurality of EMC spring contacts, and wherein at least a pair of the conductors are ground conductors and are each configured to engage a respective one of the EMC spring contacts.
